(19) United States
(12) Patent Application Publication
(10) Pub. No.: US 2007/0234336 A1
(43) Pub. Date: Oct. 4, 2007

(54) Method for electronic disk swapping in wireless network application processor system

(75) Inventors: Wen Jun Quan, Beijing (CN); Chen Jin Yan, Beijing (CN); Zi Guang Yang, Beijing (CN); Qi Wei Zhang, Beijing (CN)

Correspondence Address: MCCORMICK, PAULDING & HUBER LLP, 185 ASYLUM STREET, CITY PLACE II, HARTFORD, CT, 06103, US

(73) Assignee: Lucent Technologies Inc., Murray Hill, NJ (US)

(21) Appl. No.: 11/506,014

(22) Filed: Aug. 17, 2006

(30) Foreign Application Priority Data
Feb. 10, 2006 (CN) 200610091653.0

(51) Int. Cl. G06F 9/44

(52) U.S. Cl. 717/168

(57) ABSTRACT

An electronic disk swapping system for a wireless network application processor (AP) includes two or more hard disks connected to the AP by a SCSI bus. A disk selection unit (DSU) is connected to the hard disks and to a user interface. In operation, a user accesses the user interface to select one of the disks from which the AP will boot upon start-up. Based on this selection, a control code is generated and sent to the DSU. Based on the control code, the DSU generates a primary identifier (ID), which is applied to the selected hard disk. The “primary” ID is an identifier that the AP and/or bus associates with a source from which to automatically obtain software upon start-up of the AP. Subsequently, upon start-up, the AP determines which of the disks assigned the primary ID, and boots from that disk.

This application is entitled to the benefit of and claims foreign priority under 35 U.S.C. §119 from Chinese Patent Application No. 200610091653.0, filed Feb. 10, 2006, the disclosure of which is hereby incorporated by reference.

### FIELD OF THE INVENTION

The present invention relates to computer or microprocessor systems and, more particularly, to the control of data storage media in a processor-based wireless communication system.

### BACKGROUND OF THE INVENTION

A wireless communication network such as a cellular phone network typically includes one or more fixed base stations each with a base station controller and various transceivers and antennae for carrying out wireless, radio-frequency communications with a number of distributed wireless units. The wireless units may include mobile phones, wireless PDA's, wireless devices with high-speed data transfer capabilities, such as those compliant with “3-G” or “4-G” standards, for example, “WiFi”-equipped computer terminals, and the like. The base stations are in turn interfaced with a core data network and/or public switched telephone network through one or more network controllers or control centers, which act as the interface between the wireless/radio end of the network and the landline portion of the network, including performing the signaling functions necessary to establish calls and other data transfer to and from the wireless units. The network controller may be part of the base station equipment, or it may be a separate mobile switching center (“MSC”), radio network controller (“RNC”), or the like that services a number of base stations. Wireless communications between the base stations and wireless units are carried out using standard methods depending on the type and configuration of the wireless network. For example, the network may be a GSM network, a 1x-EVDO network, or the like. GSM is the Global System for Mobile Communications standard, used predominantly in Europe and Asia. 1x-EVDO is an implementation of the CDMA2000® “3-G”/third generation mobile telecommunications protocol/specification configured for the high-speed wireless transmission of both voice and non-voice data, used in North America.

As wireless communication technology has advanced, service providers have sought to implement more flexible and scalable control architectures. Instead of distributing control electronics across all the base stations, the trend has been to centralize the radio control function at an MSC, RNC, or the like. For example, with reference to FIG. 1, an MSC 10 in place on a wireless network 11 might include an application processor cluster (“APC”) 12 having a support frame 13 and a plurality of application processors (“AP”) 14. Each application processor is a computer module or other microprocessor-based electronics unit running software for controlling the signaling/radio interface between one or more base stations 15 and the distributed wireless units 16. The APC 12 reduces the amount of radio control hardware deployed at each base station, allows for the provision of fault tolerant or redundant configurations, and provides a common point for centralized base station administration and maintenance. Typically, the APC and/or MSC will have a network interface such as an Ethernet interface node 17 for linking the APC to a core network 18 for control and administration purposes.

With reference to FIG. 2, each AP 14 is typically outfitted with an application software program 19 that runs on the AP for carrying out communications over the network 11. Prior to deploying and using the application software 19 in the field, and as is typically the case for software in general, the application software 19 undergoes a development and testing regime at a testing and development laboratory or similar facility. For example, the testing facility may include a small-scale version of the wireless network 11 complete with the application processors 14, transceivers for simulating base station functionality, and wireless units for testing the receipt and transmission of radio-frequency signals. For testing and development purposes, the application software 19 is stored on the AP 14 in a manner that allows the application software 19 to be modified or replaced with a new or updated version of the software. Thus, the AP 14 may include a processor unit 20 connected to a hard disk or other mass storage unit 21. The application software 19 is downloaded onto the hard disk 21 from a server terminal 22 in a standard manner, and the processor unit 20 subsequently boots from the hard disk 21, e.g., upon start-up the processor unit accesses the hard disk 21 for loading and running the application software 19. When it is desired to replace the application software currently stored on the hard disk 21 with new or revised software 23, the new or revised software is downloaded from the server terminal 22 onto the hard disk 21, replacing the existing software. As should be appreciated, the AP 14 may be configured in the field (e.g., deployed at an MSC 10) in a similar manner. Thus, each AP 14 in place at the MSC 10 (see FIG. 1) may have a hard disk or other mass storage device for storing application software 19.

Especially in a testing and development environment, the application software 19 in place on an AP hard disk 21 may need to be frequently replaced. For example, it may be the case that a number of different revisions or modifications have to be tested, or that different users have to use the same AP for testing different application software programs. For replacing the application software on an AP hard disk 21, it is possible to download the new software 23 from a server terminal 22, as described above. However, downloading the application software, which is typically quite large, may take up to two hours. Moreover, if using only one hard disk 21, the physical memory medium of the hard disk will be read and re-written so many times that damage is possible. Another possible option for providing different software programs to an AP is to download the different software programs into several hard disks, and to then manually swap disks when a user requests. This would likely save time overall, but since the disks have to be manually physically swapped, this requires that a engineer or other person be present at all times when disk swapping is to be carried out. If swapping is required on a holiday or at night, this will be an inconvenience and may be costly in terms of human resources and working efficiency. Robotic systems are available for automatically physically switching mass storage, but these are very expensive and would be not be cost effective unless a very large number of hard disks were involved, which is not the case for an AP system.

### SUMMARY OF THE INVENTION

An embodiment of the present invention relates to a method and system for configuring storage media for communication with a processor unit. The storage mediums may be connected to the processor unit by way of a communication/data bus. By “storage medium,” it is meant an electronic device for storing data such as computer software, e.g., a hard disk, a magnetic tape unit, a memory unit, or the like. The processor unit is an electronic device configured for using the software or other data stored in the storage media, such as a computer or wireless network application processor. A control code (e.g., electronic message, signal, command, or the like) is received and used as a basis for assigning a primary identifier (“ID”) to a designated or selected one of the storage mediums. The “primary” ID is an identifier that the processor unit and/or communication bus associates with a source from which to obtain software, e.g., for automatic booting of the processor unit upon start-up. Thus, based on the primary ID, software stored on the designated storage medium is transferred over the communication bus to the processor unit.

In another embodiment, a unique ID is assigned to each of the storage mediums, as determined from the content of the control code. The unique ID assigned to the selected disk is the primary ID.

In another embodiment, the storage mediums are computer hard disks, and the method is used for electronic hard disk swapping in a wireless network application processor system. The hard disks are connected to an application processor by a communication bus. A user selects the designated hard disk from a user interface module. For example, from among the various hard disks, the user selects the hard disk from which the application processor is to obtain software upon start-up. The control code is automatically generated based on the user selection.

In another embodiment, the communication bus is a SCSI bus, which may be part of the application processor system. Here, the primary ID and other unique ID's are SCSI device ID's used for identifying devices for communication purposes on the SCSI bus. Each SCSI ID will typically be a two (or more) digit binary number, such as “00” for the primary ID and “01,” “10,” and/or “11” for the other unique identifiers. The length of the ID's may depend on the number of storage mediums connected to the bus and/or the type of SCSI bus used.

In another embodiment, the ID's (including the primary ID) are assigned to the storage mediums by generating the ID's from the control code and then applying the ID's to the storage mediums. For example, the ID's may be generated using a selection unit attached to the storage mediums. The control code is routed to the input of the selection unit, which converts the control code into the particular ID's to be assigned to the storage mediums, as indicated by the content of the control code. The ID's outputted by the selection unit are respectively routed to the storage mediums, as appropriate. The storage mediums will typically each have an electrical input for accepting an ID-related signal. Upon start-up, the storage medium with the primary ID (and possibly the other storage mediums) transmits its ID to the processor unit, which enables the processor unit to determine which of the storage mediums has the primary ID assigned thereto.

In another embodiment, the selection unit includes a microprocessor and a logic circuit. The inputs of the logic circuit are connected to the microprocessor, and the outputs of the logic circuit are connected to the storage mediums, e.g., the logic circuit has an output connected to each storage medium. (By “output” or“input” as used herein, it is meant one or more lines or other electrical conductors capable of carrying an electrical signal.) The microprocessor converts the control code into a logic input signal directed into the logic circuit. The logic circuit converts the logic input signal to produce the unique ID for each storage medium at the appropriate output of the logic circuit.

In another embodiment, the user interface module for selecting a storage medium and generating the control code is located at the same location as the storage mediums and processor unit, e.g., in a testing laboratory. Alternatively, the user interface module and storage mediums may be located at remote locations. By “remote,” it is meant that the user interface module is at a location where the storage mediums are not physically accessible.

### BRIEF DESCRIPTION OF THE DRAWINGS

The present invention will be better understood from reading the following description of non-limiting embodiments, with reference to the attached drawings, wherein below:

FIG. 1 is a schematic diagram of a wireless communication network;

FIG. 2 is a schematic diagram showing the replacement of software in an application processor (“AP”), according to the prior art;

FIGS. 3 and 8 are schematic diagrams of an electronic disk swapping system according to an embodiment of the present invention;

FIGS. 4 and 5 are schematic diagrams of a disk array system portion of the disk swapping system;

FIGS. 6 and 7 are schematic diagrams of a disk selection unit portion of the disk swapping system; and

FIG. 9 is a flow chart showing operation of an embodiment of the disk swapping system.

### DETAILED DESCRIPTION

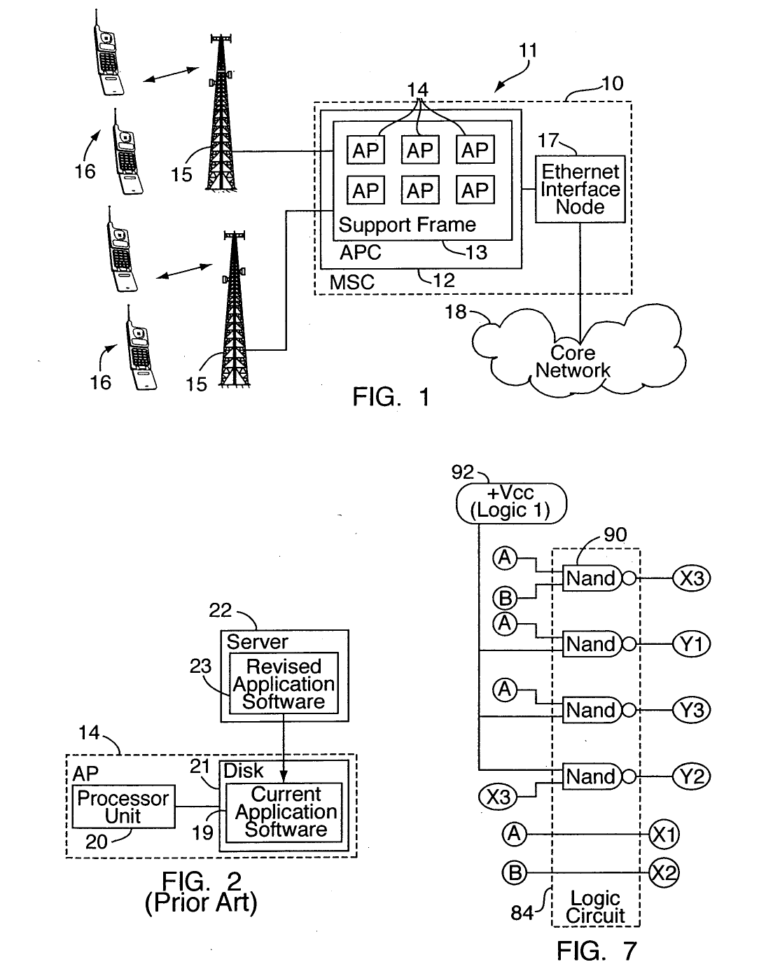

With reference to FIGS. 1 and 3-9, an electronic disk swapping system 26 is used in conjunction with a wireless network application processor cluster (“APC”) 12. The APC 12 includes a support frame 13 holding at least one application processor (“AP”) 14. The AP 14 is connected to a disk array system 28 by way of a SCSI or other communication bus 30. The disk array system 28 includes a disk array 32 having two or more hard disks/drives or other data storage mediums 34a-34c, each connected to the bus 30. A disk selection unit 36 is connected to the hard disks 34a-34c and (directly or indirectly) to a user interface module 38. In operation, a user accesses a user interface portion 40 of the module 38 to electronically “swap” the hard disks. In particular, from among the hard disks 34a-34c in the array 32, the user selects the “boot” disk, e.g., disk 34a, from which the user would like the AP 14 to obtain software upon start-up. Based on the user selection, the user interface module 38 generates a control code 42, which is sent to the disk selection unit 36. The disk selection unit 36 uses the control code 42 to generate a primary identifier (“ID”) 44, which is applied to the selected hard disk 34a. The “primary” ID is an identifier that the AP 14 and/or communication bus 30 associates with a source from which to automatically obtain software, e.g., upon start-up of the AP. Subsequently, upon start-up of the AP 14, the AP 14 identifies the selected disk 34a by determining which of the disks 34a-34c was assigned the primary ID 44, and boots from that disk (that is, automatically obtains software from the disk). Typically, the selection unit 36 will be configured to generate a unique ID 46a-46c for each of the disks 34a-34c, based on the content of the control code 42, with the unique ID of the selected disk 34a being the primary ID 44. Based on the control code, the generation and application of the unique ID's 46a-46c may be done in an automatic electrical manner, by which it is meant through the manipulation of electrical signals without human action or input.

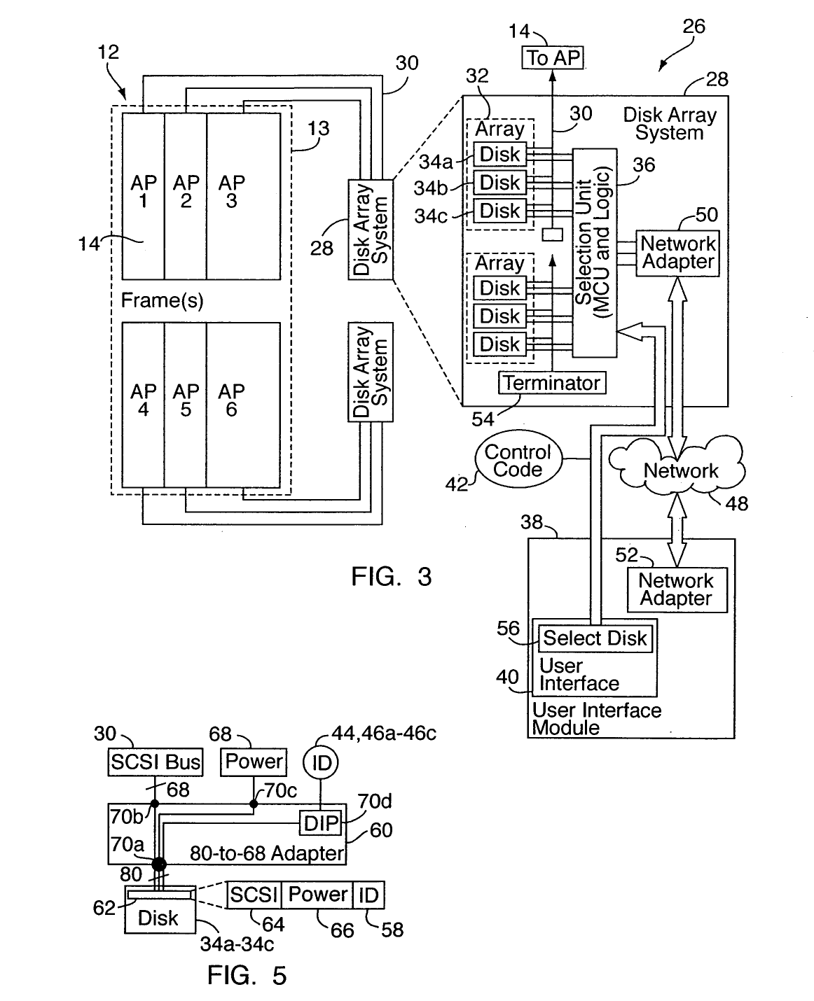

FIG. 3 shows an overview of the disk swapping system 26, which will primarily be explained herein with respect to a single AP 14. The AP 14 is connected to a disk array 32 by way of a SCSI or other communication bus 30. The disk array 32 includes two or more hard disks or other data storage mediums; for example, three hard disks 34a-34c are shown in the drawings. Each hard disk 34a-34c is connected to the bus 30. Each disk 34a-34c is also connected to the selection unit 36, for assignment of the identifiers 46a-46c, as further explained below. The selection unit 36 may in turn be directly electrically connected to the user interface module 38, or it may be indirectly connected thereto over a network 48. For communication between the user interface module 38 and selection unit 36 over the network 48, the selection unit 36 may include or otherwise be connected to a network adapter 50. Similarly, the user interface module 38 includes a network adapter 52. The network 48 may be a standard Ethernet system or other local-area network, and the network adapters 50, 52 may be standard Ethernet adapters. The network adapter 50 for the selection unit 36 may be an Ethernet-to-serial translation module. Depending on the type of communication bus used, one or more standard bus terminators 54 may be connected to the communication bus 30. For example, the standards for certain SCSI buses recommend the use of bus terminators. A bus terminator is an electrical circuit that complements the electrical characteristics of the bus, in light of the communication protocol(s) in place on the bus, for purposes of facilitating reliable data transfer and other communications over the bus.

The user interface module 38 may be implemented as a software program, a suite of software programs, a hardware or hardware/software module, or the like, either in a stand-alone manner or in conjunction with one or more standard components. For example, the user interface module 38 may be a script or other software program running on a computer terminal. The user interface module 38 includes the user interface 40, which may be a GUI (graphical user interface), a command or command-line interface, or the like. The user interface 40 has a “disk select” function 56, which displays (or otherwise indicates) the disks 34a-34c in the disk array 32 and/or the disks connected to the AP 14, including displaying identifying information for each disk for the user to determine “which disk is which.” Using the disk select function 56, the user is able to select the boot disk that will be assigned the primary ID 44. The user may also be able to select the ID's to be assigned to the other disks in the array, and/or the “order” of the disks as relating to communications over the bus 30.

To explain further, each ID 44, 46a-46c is used to identify a disk for purposes of communicating over the bus 30. The primary ID 44 is a specific identifier that the system 26 recognizes for the initial loading of software into the AP 14 upon start-up. “Start-up” refers to an initial state of the AP such as power-up, a reset situation, or the like. Thus, upon start-up the AP 14 boots from the disk associated with the primary ID 44, that is, the AP obtains software from the disk for running on the AP. For example, the software may be application software for controlling communications over the network 11. The ID's 44, 46a-46c may be specific to the system 26, and/or they may be based on the AP 14 and communication bus 30. More specifically, the specifications or standards for certain communication buses set forth the manner in which storage mediums connected thereto should be identified for communication over the bus. An Ultra-Wide SCSI bus or other SCSI bus, for example, as frequently used to connect an AP to a disk array, has specific disk ID codes for identifying devices (storage mediums or other electronic devices such as scanners and printers) on the bus. Each SCSI device ID is a two or more digit binary number, depending on the particular SCSI bus. (There are several types of SCSI busses.) For example, in a typical SCSI bus the primary ID 44 might be “0000,” with additional ID's being “0001,” “0010,” “0011,” and so on, each being assigned to one and only one device on the bus. The hard disks 34a-34c or other storage mediums will typically be especially electrically/physically configured for communicating over the bus 30. For example, if the bus 30 is a SCSI bus, the hard disks 34a-34c will be SCSI hard disks. Each hard disk will typically have a terminal or connector 58 (see FIG. 5) to which a signal can be applied for assigning an ID.

In the case of a SCSI bus 30, upon start-up of the AP, the ID of each disk 34a-34c connected thereto is supplied to the AP, e.g., the AP might poll each disk for its ID, or the disk might automatically transmit its ID. It may also be the case that only the disk with the primary ID transmits its ID. The AP 14 subsequently determines which disk has the primary ID 44, and obtains software from it over the bus 30 in a standard manner. As should be appreciated, the AP will typically include a communication bus controller, by which it is meant a control circuit (such as a separate bus controller) and/or bus control functionality integral with the AP. Thus, when referring to a processor unit, AP, or application processor herein, it is meant a processor unit and/or communication bus controller.

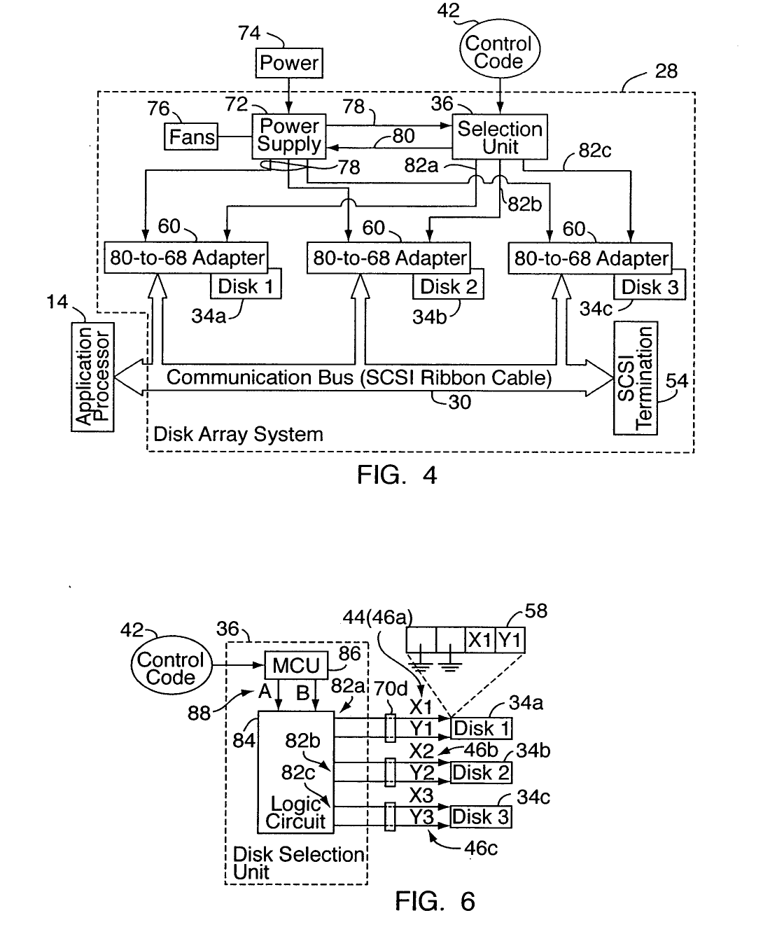

FIGS. 4 and 5 show a more detailed view of one example of how the hard disks 34a-34c may be connected to the AP 14 and selection unit 36. The AP 14 is connected to the communication bus 30, which will typically be physically implemented using a ribbon cable and one or more bus terminators 54. Each disk 34a-34c is connected to the ribbon cable in parallel through an 80-to-68 adapter 60, if necessary. To explain further, the bus ribbon cable 30 has a number of signal pathways, e.g., wires or other conductors; the exact number will depend on the communication bus 30. Each disk 34a-34c has a connector 62 for connecting the disk to a communication bus. The connector 62 will typically include a number of pins for the mechanical and electrical attachment of a complementary ribbon cable connector; the exact number of pins in the connector 62 will depend on the particular configuration of the disk. Therefore, if the disk connectors 62 and ribbon cable 30 do not directly match, it may be necessary to provide the adapters 60. For example, a common situation arises when using so-called “SCA” SCSI disks. SCA is short for “single connector attachment,” and refers to a disk connector 62 that includes a terminal 64 not only for the bus cable 30, but also an integral terminal 66 for power and an integral terminal 58 for device ID signals. (By “terminal,” it is meant one or more individual electrical connections, e.g., pins.) In the case of the disks 34a-34c shown in FIGS. 4 and 5, each disk has an 80-pin connector 62. The 80-pin connector 62 includes a terminal 64 for the SCSI bus, a terminal 66 for power signals 68 (possibly including one or more ground connections, one or more voltage inputs, and one or more connections for power control signals), and a terminal 58 for the application of a device ID signal 44, 46a-46c. The disk connector 62 is attached to an 80-pin connector 70a of the adapter 60, which routes the eighty signal pathways thereof to three separate connectors: a 68-pin connector 70b for attaching the SCSI ribbon cable 30, a connector 70c for power-related signals 68, and a connector 70d for device ID-related signals. One or more of the connectors may be dual inline package (“DIP”) connectors. As should be appreciated, other disk drives may have separate connectors for the bus 30, power-related signals 68, and device ID-related signals 44, 46a-46c, in which case adapters 60 would not be needed.

Referring particularly to FIG. 4, the disk array system 28 further includes a power supply 72. Input power is supplied to the power supply 72 from a standard power source 74, e.g., a 220V AC outlet or line. The power supply 72 provides power to one or more fan units 76, provided for cooling the disks 34a-34c or similar purposes. The power supply 72 also supplies power signals (e.g., grounds and voltage sources) to the disks 34a-34c and selection unit 36 via power lines 78. A power control line 80 may be connected between the selection unit 36 and the power supply 72. The power control line 80 is used by the selection unit 36 as a signal pathway for controlling the power supply 72. For example, if the selection unit 36 applies an “off” signal, e.g., a binary “1” voltage, to the line 80 the power outputs to the disks are disabled (turned off), and if the selection unit applies an “on” signal, e.g., a binary “0” voltage (ground), the power outputs to the disks are enabled (turned on). The selection unit 36 also has output lines 82a-82c respectively connected to the disks 34a-34c, through the adapters 60, for applying the ID signals 44, 46a-46c.

The generation and application of the control code 42 and ID's 44, 46a-46c will now be further described with reference to FIGS. 6 and 7. As noted, the selection unit 36 is configured to accept the control code 42 as input, and to generate the ID signals 44, 46a-46c for application to the disks 34a-34c, based on the content of the control code and, correspondingly, the user selection of the disk to which the primary ID 44 is to be assigned. For example, if the user selects disk 34a as the disk for assigning the primary ID 44, the user interface module 38 will generate a control code 42 having content to that effect, such as:

| DISK # | SELECTION | BUS ID |
|---|---|---|
| 34a | 1 (primary) | 0000 |
| 34b | 2 | 0001 |
| 34c | 3 | 0010 |

As should be appreciated, an actual control code would be formatted as a message, signal, command, or the like, in a more compact manner suitable for transfer between the user interface module and selection unit. The control code may be included in a message such as:

| | | |
|---|---|---|
| HEADER | CONTROL CODE | FOOTER |

Here, the optional header and footer would be used for communication purposes, e.g., error checking, validation, and to delineate the “control code” portion. The control code portion would be a binary code such as:

| DISK | ORDER | | | | | |
|---|---|---|---|---|---|---|
| 34a | Primary | Primary | 2 | 2 | 3 | 3 |
| 34b | 2 | 3 | Primary | 3 | Primary | 2 |
| 34c | 3 | 2 | 3 | Primary | 2 | Primary |
| CODE: | 000 | 001 | 010 | 011 | 100 | 101 |

### For example, a control code of “001” would indicate that the user has selected disk 34a to be assigned the primary ID, disk 34b to be assigned a tertiary ID, and disk 34c a secondary ID.

Where the “order” of the disk determines the ID 44, 46a-46c in the bus 30, it is only necessary to provide information relating to the selected order and not the ID's associated with that order. For example, if the primary ID for a SCSI bus is “0000,” it is only necessary to designate/identify the disk to which the primary ID will be assigned; it is not necessary to include the actual ID of “0000.” Thus, upon receiving a particular control code, the selection unit 36 generates the ID's 44, 46a-46c based on the control code. An example follows, keeping in mind that for a SCSI bus (in this example at least) the primary ID 44 is “0000,” the ID for a second disk is “0001,” and the ID for a third disk is “0010”:

| CONTROL | DISK | DISK | DISK |
|---|---|---|---|
| CODE | 34a ID | 34b ID | 34c ID |
| 000 | 0000 | 0010 | 0011 |
| 001 | 0000 | 0011 | 0010 |
| 010 | 0010 | 0000 | 0011 |
| 011 | 0010 | 0011 | 0000 |
| 100 | 0011 | 0000 | 0010 |
| 101 | 0011 | 0010 | 0000 |

Although a particular control code is described above, any number of different codes, code formats, or the like could be used instead. Also, the “order” of the disks having “non-primary” ID's may not matter, e.g., if disk 34a is assigned the primary ID “0000,” it may not matter which disk 34b or 34c has ID “0001” and which has ID “0010.” In such a case, the control code 42 is simplified by arbitrarily assigning the non-primary ID's. For example:

| CONTROL | DISK | DISK | DISK |
|---|---|---|---|
| CODE | 34a ID | 34b ID | 34c ID |
| 01 | 0000 | 0010 | 0011 |
| 10 | 0011 | 0000 | 0010 |
| 11 | 0010 | 0011 | 0000 |

To serve as another example, this code is different from the one above, in that “01” (digital 1) is used to indicate that the first disk 34a is to be assigned the primary ID, “10” (digital 2) is used for the second disk 34b, and “11” (digital 3) is used for the third disk 34c.

From the control code 42, the ID's 44, 46a-46c may be generated in a number of different ways. If the ID's are binary, a logic circuit 84 is suitable. For example, as shown in FIG. 6, the disk selection unit 36 may include a microprocessor 86 (“MCU”) and the logic circuit 84. The MCU 86 is a standard microprocessor configured to accept the control code 42 as input, and to generate a logic signal 88 based on the control code 42. The logic signal 88 is applied to the logic circuit 84 for generating the ID's. The logic signal 88 may be the same as the control code 42, with the MCU 86 in effect isolating the control code 42 from any attendant data included in a message as described above. In other words, if the control code is part of a message in the format “HEADER:CONTROL CODE:FOOTER,” the MCU 86 could isolate the control code portion and apply it to the logic circuit 84 as the logic signal 88.

FIG. 7 shows one example of a logic circuit 84 suitable for generating ID's as set forth above. The logic circuit 84 includes a number of NAND logic gates 90, three signal inputs in effect (signals “A” and “B” as the logic input signal 88 from the MCU 86, and logic “1”/+Vcc 92), and the outputs 82a-82c respectively connected to the disks 34a-34c. The NAND gates 90 may be provided by way of a standard monolithic IC module, or using discreet components. Each output 82a-82c includes two signal lines (X1, Y1), (X2, Y2), and (X3, Y3), respectively. The logic diagram of the circuit 84 in FIG. 7 is as follows, which corresponds to the table above:

| AB | X1Y1 | X2Y2 | X3Y3 |
|---|---|---|---|
| 01 | 00 | 10 | 11 |
| 10 | 11 | 00 | 10 |
| 11 | 10 | 11 | 00 |

For example, when the MSU 86 outputs a logic signal 88 of (A=1, B=0) into the circuit 84 in FIG. 7, the outputs of the circuit 84 are X1=1, Y1=1, X2=0, Y2=0, X3=1, and Y3=0. Depending on the particular bus 30 used in the system 26, the ID's for devices connected to the bus may extend to two, three, four, or more digits, e.g., “00,” “000,” or “0000.” In such a case, where fewer than the maximum number of devices are used, the most significant digits for each device may be permanently set to logic “0” by attaching a ground jumper or the like, either directly to the disk inputs or to the lines that feed the inputs. For example, if the bus normally specifies a four digit ID (allowing for sixteen devices each with a different ID), but only three devices are attached to the bus, only the two least significant digits will vary, per the table above. Accordingly, as indicated in FIG. 6, the two most significant inputs of the ID terminal 58 of each disk may be connected to ground (logic 0).

For booting from the disk assigned the primary ID, the AP 14 may have to be in an initial state, as noted above. Therefore, the user interface module 38, the disk selection unit 36, and/or some other component in the system 26 may be configured to issue a standard “power down” or “reset” command to the AP 14 along with, as part of, or upon receipt of the control code 42.

As part of the disk swapping process, it will typically be the case that different software programs are downloaded into the different disks 34a-34c connected to an AP 14, to allow a user to select among the different disks for either testing the different software programs or for having the AP execute the different programs for some other reason. For example, it may be desired to provide the AP with new or updated application software while minimizing the down time of the AP, or it may be the case that different programs are used for controlling communications in the network 11 at different times or in different operational situations. The user interface module 38 may be further configured for user selection and download of software into the disks or other storage media 34a-34c.

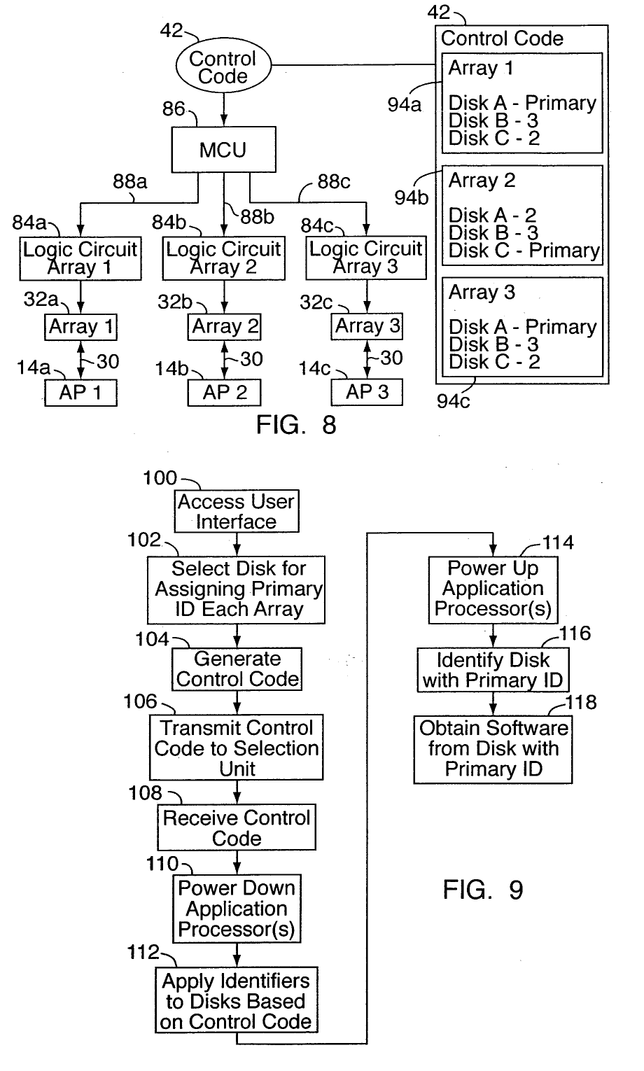

As indicated in FIG. 3, the system 26 can be scaled for use with any number of AP's and disk arrays. A more detailed example is shown in FIG. 8. There, each of three (or more) AP's 14a-14c is respectively connected to a disk array 32a-32c via a communication bus 30. Each array includes two or more hard disks or other storage mediums. A logic circuit 84a-84c is connected to the disks in each disk array 32a-32c in a manner as described above. A typical MCU 86 will have the capacity to control more than one logic circuit, e.g., it will have a plurality of controllable output pins for outputting a logic control signal 88 (e.g., “A” and “B”) for each logic circuit. Thus, only one MCU 86 may be required for a system as shown in FIGS. 3 and 8. For such a configuration, the control code 42 may include information for identifying a single disk array only; in other words, a control code message may be sent for each disk array individually. Alternatively, as shown schematically in FIG. 8, the control code 42 may contain control data 94a-94c for controlling all the disk arrays 32a-32c in the system, respectively.

FIG. 9 summarizes the operation of an embodiment of the storage medium swapping system 26. At Step 100, a user accesses the user interface module 38. At Step 102, using the user interface 40, the user selects a disk 34a in an array 32 that will be assigned the primary ID 44. If there is more than one array, the user may select a disk in each array to which the primary ID will be assigned. At Step 104, the user interface module 38 generates the control code 42 based on the user's selection(s). At Step 106, the control code 42 is sent to the selection unit 36. At Step 108, the control code 42 is received by the selection unit. At Step 110, the application processor(s) 14 is powered down or otherwise controlled to an initial state, if needed. At Step 112, based on the content of the control code 42, the selection unit 36 generates the unique identifiers 46a-46c and concurrently applies them to the disks 34a-34c in the array 32. The unique identifier applied to the disk 34a selected by the user is the primary ID 44 for the communication bus 30 and/or AP 14. At Step 114, the AP 14 is powered up, and then boots from the disk 34a to which the primary ID 44 was assigned. This may involve first identifying the disk 34a assigned the primary ID 44, as at Step 116. For example, the AP may poll the hard disks 34a-34c, or the disk 34a with the primary ID 44 may be configured to transmit signals to the AP over the bus 30 for informing the AP that it has been assigned the primary ID. At Step 118, the AP obtains software from the disk 34a with the primary ID in a standard manner over the communication bus 30. Subsequently, the AP executes the software, e.g., for controlling communications over the wireless network 11, for testing purposes in a testing lab, or the like.

The user interface module 38 may be located at the same location as the hard disks 34a-34c and AP 14, such as in a testing laboratory. Alternatively, the user interface module 38 and hard disks, etc. may be deployed at locations remote from one another. This means that the user interface module 38 would be at a location where a person could not physically access the hard disks, such as in another room in the same building, or at an administration facility with the hard disks being located at an MSC in another building.

Since certain changes may be made in the above-described electronic disk swapping system and method, without departing from the spirit and scope of the invention herein involved, it is intended that all of the subject matter of the above description or shown in the accompanying drawings shall be interpreted merely as examples illustrating the inventive concept herein and shall not be construed as limiting the invention.

We claim:

1. A method for configuring storage media for communication with a processor unit, said method comprising the steps of:
electronically assigning a primary identifier (ID) to a designated one of a plurality of storage mediums based on a received control code; and
transferring software stored on said designated storage medium to a processor unit based on said primary ID.

2. The method of claim 1 further comprising the step of:
electronically assigning a unique ID code to each of said plurality of storage mediums based on the control code, wherein the unique ID assigned to the designated storage medium is the primary ID.

3. The method of claim 2 wherein the control code is received over a communication network from a location remote from the processor unit and storage mediums.

4. The method of claim 3 further comprising the steps of:
selecting the designated storage medium at the remote location through a user interface module interfaced with the communication network;
generating the control code based on the selected designated storage medium; and
transmitting the control code over the communication network.

5. The method of claim 2 wherein:
the processor unit is an application processor for controlling communications in a wireless network;
each storage medium is a hard disk connected to the application processor by a SCSI communication bus; and
each unique ID is a SCSI ID code having at least two binary digits.

6. The method of claim 2 further comprising the steps of:
generating the unique ID's based on the received control code; and
respectively applying the unique ID's to the plurality of storage mediums, wherein at least the designated storage medium is configured to transfer the primary ID to the processor unit for determination of the designated storage medium among said plurality of storage mediums.

7. The method of claim 6 wherein the unique ID's are generated and applied to the plurality of storage mediums at least in part by a logic circuit connected to the plurality of storage mediums.

8. The method of claim 7 further comprising the steps of:
generating a logic input signal based on the control code; and
applying the logic input signal to the logic circuit to generate the unique ID's on at least one output of the logic circuit, said at least one output being connected to the plurality of storage mediums.

9. The method of claim 8 wherein the logic input signal is generated by a microprocessor connected to the logic circuit, said control code being applied to an input of the microprocessor.

10. A method for electronic disk swapping in a wireless network application processor system, said method comprising the steps of:
selecting a hard disk through a user interface, wherein the selected hard disk is one of a plurality of hard disks connected to a wireless network application processor unit, said processor unit being configured to obtain software from any one of said hard disks having a primary identifier (ID); and
electronically assigning an ID to each of the plurality of hard disks based on the selected hard disk, wherein the ID assigned to the selected hard disk is the primary ID.

11. The method of claim 10 wherein:
each ID is a unique ID; and the method further comprises the steps of:
generating a control code based on the selected hard disk;
generating the unique ID's based on the control code; and
applying the unique ID's to the hard disks, wherein the unique ID's are generated and applied to the hard disks at least in part by a logic circuit connected to the hard disks.

12. The method of claim 11 further comprising the steps of:
generating a logic input signal based on the control code; and
applying the logic input signal to the logic circuit to generate the unique ID's on respective outputs of the logic circuit, said outputs being connected to the hard disks.

13. The method of claim 12 wherein the logic input signal is generated by a microprocessor connected to the logic circuit, said control code being applied to an input of the microprocessor.

14. The method of claim 11 wherein:
the application processor and plurality of hard disks are located at a first location;
the control code is generated at a second location remote from the first location; and
the method further comprises transmitting the control code from the second location to the first location, for generating the unique ID's at the first location.

15. The method of claim 11 wherein:
the application processor unit comprises a processor and a SCSI communication bus, said communication bus interconnecting the processor and the hard disks; and
each unique ID is a unique SCSI ID code having at least two binary digits.

16. A storage media system comprising:
a processor unit, and a plurality of storage mediums connected to the processor unit, wherein the processor unit is configured to obtain software from any one of said storage mediums having a primary identifier (ID); and
a media selection unit connected to the plurality of storage mediums, said selection unit being configured to electrically assign the primary ID to a selected one of said storage mediums based on a received control code.

17. The system of claim 16 wherein the selection unit is configured to electrically assign a unique ID to each of said plurality of storage mediums, wherein the unique ID assigned to the selected storage medium is the primary ID.

18. The system of claim 17 wherein the media selection unit comprises:
a microprocessor configured to generate a logic signal based on the control code; and
a logic circuit connected to the microprocessor and to the storage mediums, wherein the logic circuit is configured to generate the unique ID's for applying to the storage mediums based on the logic signal.

19. The system of claim 18 wherein:
the processor unit comprises a wireless network application processor and a SCSI communication bus, said communication bus interconnecting the application processor and the plurality of storage mediums; and
each unique ID is a SCSI ID code having at least two binary digits

20. The system of claim 28 further comprising:
a user interface configured for user selection of one of said plurality of storage mediums for assignment of the primary ID, wherein the user interface is further configured to generate the control code based on the selected storage medium.
